(19) United States
(12) Patent Application Publication
(10) Pub. No.: US 2013/0110732 A1
(43) Pub. Date: May 2, 2013

(54) SYSTEM AND METHOD FOR EVALUATING TRUSTWORTHINESS OF USERS IN A SOCIAL NETWORK

(71) Applicant: NetOrbis Social Media Private Limited, Delhi (IN)

(72) Inventor: Rahul Uppal, Delhi (IN)

(73) Assignee: NetOrbis Social Media Private Limited, Delhi (IN)

(21) Appl. No.: 13/662,075

(22) Filed: Oct. 26, 2012

(30) Foreign Application Priority Data
Oct. 27, 2011 (IN) 3063/DEL/2011

(51) Int. Cl. G06Q 99/00

(52) U.S. Cl. 705/319

(57) ABSTRACT

Disclosed is a method and system for evaluating trustworthiness of individuals and organizations in a social network. In one embodiment, the system includes a user account module configured to create a user profile, an expertise module configured to update the created user profile with a one or more first expertise, a reviewer invite module configured to send invites to a one or more reviewers to evaluate the one or more first expertise and a one or more second expertise, a rating module configured to capture ratings from the one or more reviewers for the one or more first expertise updated by the user and the one or more second expertise, and a computation module configured to compute a trustworthiness score based on the captured ratings.

### CROSS-REFERENCE TO RELATED APPLICATIONS

This application claims priority to India Patent Application No. 3063/DEL/2011, filed on Oct. 27, 2011, the entirety of which is hereby incorporated by reference.

### FIELD OF THE INVENTION

The present invention relates to an evaluation system, more particularly, to evaluate trustworthiness of individuals and organizations in a social network.

### BACKGROUND

Today, one of the factors for achieving globalization is a social media platform. The social media platform, along with the internet, facilitates interactions between individuals and/or organizations for various purposes, such as sharing similar interests, collecting opinions, spreading knowledge, and the like.

Social media platforms may be broadly classified as personal social media platforms, professional social media platforms and business social media platforms. Further, business social media platforms may be classified in intra-corporate and business-to-business (B2B) platforms. Personal social media platforms facilitate individuals exchanging information and collaborating with personal contacts. In general, personal social media platforms are for like-minded individuals, or for a person to exchange information among a group of people that person is interested in. Professional social media platforms facilitate individuals and organizations collaborating and sharing work related information between professionals. Business social media platforms enable business to leverage social media for tapping into internal social media networks, such as intra-corporate social media platforms.

Currently, existing business social media platforms do not provide comprehensive information about companies and organizations down to their sub-organizational units. It is fairly difficult to get in touch with the right resources, or people having the required expertise, using existing social media platforms. Further, with an exponential increase in the number of people in business platforms, there are no means to evaluate trustworthiness of the people joining a platform, which makes the business platform less secure.

### SUMMARY OF THE INVENTION

A system and a method for evaluating trustworthiness of a user in a social network system are provided herein. In one embodiment, the system to evaluate trustworthiness of the user in the social network includes a user account module configured to create a user profile, an expertise module to update the created user profile with a one or more first expertise, a reviewer invite module to invites reviewers to evaluate and rate the user for the updated one or more first expertise and a one or more second expertise, a rating module configured to capture ratings received in relation to the first expertise and the second expertise from the one or more reviewers, and a computation module configured to compute a domain rating, a trust rating, and a trustworthiness score. The user invites ore or more reviewers to rate the user in relation to the updated one or more first expertise, the rating module captures the ratings received from the one or more reviewers in relation to the updated one or more first expertise and additionally a second expertise, and the computation module calculates a trustworthiness score based on the ratings captured by the rating module.

In another embodiment, a method for evaluating trustworthiness of a user in a social network system is provided, the method comprising the steps of, receiving a request from a user for updating a user profile with a one or more first expertise, receiving ratings from a one or more reviewers, invited by the user, for the updated one or more first expertise and additionally a one or more second expertise, computing a domain rating, a trust rating, and a trustworthiness score, at a processor of a computer, based upon the rating received from the one or more reviewers, and displaying the computed domain rating, the trust rating, and the trustworthiness score on the user profile.

### BRIEF DESCRIPTION OF THE DRAWINGS

FIG. 1 shows a block diagram of a client-server architecture, in the context of the present disclosure.

FIG. 2 shows a block diagram of the client-server architecture including functional components, in the context of the present disclosure.

FIG. 3 shows a computer system to evaluate trustworthiness of individuals and organizations in a social network, according to an embodiment of the present disclosure.

FIG. 4 shows a flowchart of a computer-implemented method for evaluating trustworthiness of individuals and organizations in a social network, according to an embodiment of the present disclosure.

FIG. 5 shows a flowchart for evaluating a one or more expertise and a one or more second expertise by a reviewer, according to an embodiment of the present disclosure.

FIG. 6 shows an exemplary table including computed trustworthiness score, domain rating, and trust rating for an individual, according to an embodiment of the invention.

FIG. 7 shows an exemplary table including computed trustworthiness score, domain rating, and trust rating for an organization, according to an embodiment of the present invention.

### DETAILED DESCRIPTION OF THE DRAWINGS

The exemplary embodiments described herein in detail for illustrative purposes are subject to many variations in structure and design.

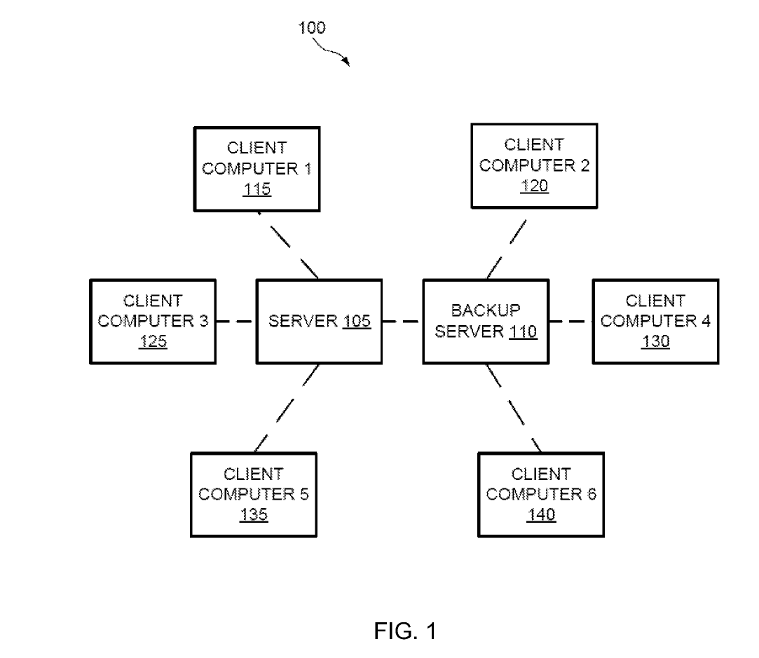

FIG. 1 illustrates a block diagram of a client-server architecture 100 in the context of the present disclosure. The client-server architecture 100 includes a plurality of servers such as server 105 and backup server 110, and a plurality of client computers such as client computer 1 115, client computer 2 120, client computer 3 125, client computer 4 130, client computer 5 135 and client computer 6 140. The plurality of client computers may include, but is not restricted to, desktop computers or handheld mobile devices configured to access the internet and/or a social network system that may reside on the internet.

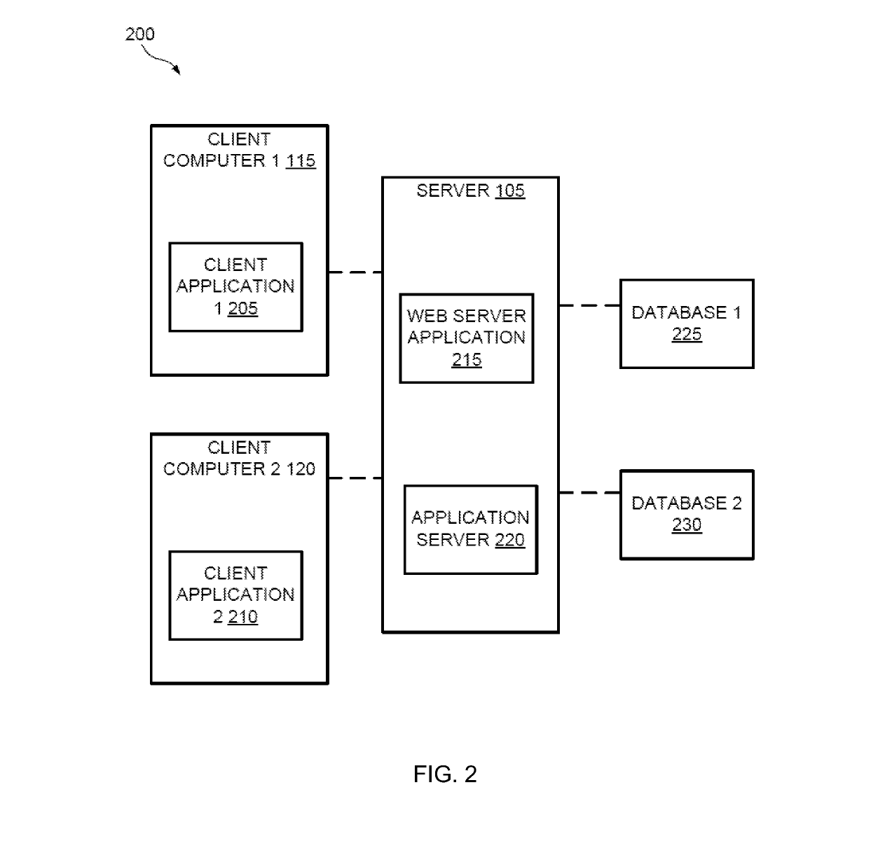

FIG. 2 illustrates a block diagram of the client-server architecture 200 including functional components, in the context of the present disclosure. The client-server architecture 200 includes client computer 115 and client computer 120 of FIG. 1. The client computer 115 and the client computer 120 further include client application 205 and client application 210, respectively. The client application 205 and client application 210 are configured to use a web browser known in the art to facilitate a user to create a user profile in a social network.

The client application 205 and client application 210 may reside in an on-board storage of the client-computer 115 and client computer 120, or may be stored on the server 105 connected to the client computer 115 and client computer 120 from where it can be downloaded using the web browser on demand. The client application 205 and client application 210 are further configured to access a server-side software which may reside on the server 105. The server 105 further includes a web server application 215 and an application server 220. The web server application 215 is capable of performing conventional web server functions. The server 105 has accesses to one or more databases, such as database 1 225 and database 2 230, which communicate with the web server application 215 and the application server 220 and provide storage facility for these applications.

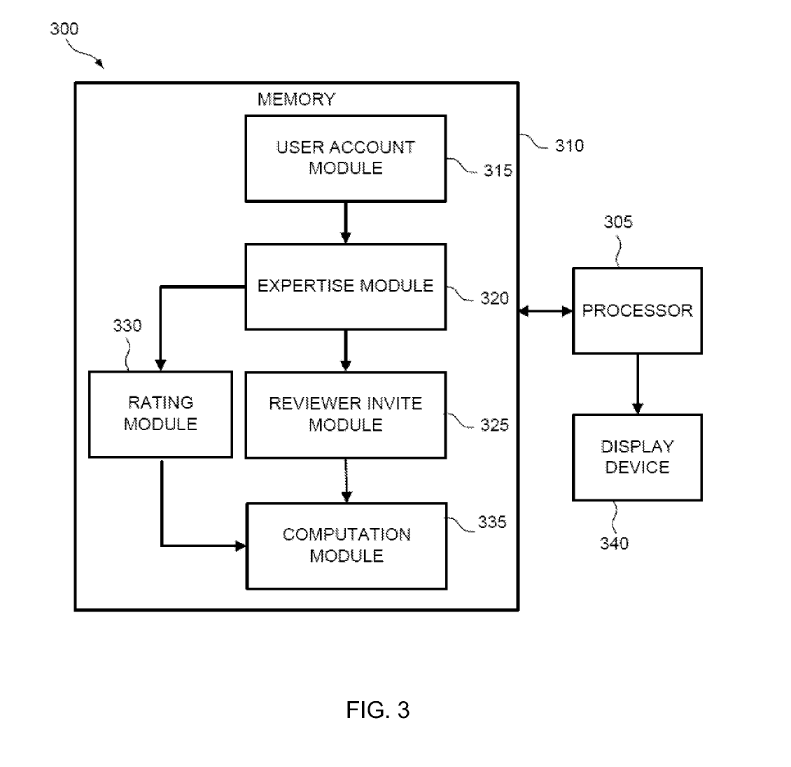

FIG. 3 illustrates a computer system 300 to evaluate trustworthiness of a user in a social network, according to an embodiment of the present disclosure. The computer system 300 includes a processor 305, a memory 310 and a display device 340. The memory 310 further includes a user account module 315, an expertise module 320, a reviewer invite module 325, a rating module 330 and a computation module 335. The memory 310 comprises a non-transitory computer-readable medium. The user account module 315, expertise module 320, reviewer invite module 325, rating module 330 and computation module 335 comprise computer-readable instructions that may be executed by the processor 305. In one embodiment, the computer system 300 may reside in the application server 220 of FIG. 2. In another embodiment, the display device 340 may be a display of a client computer which may include, but is not restricted to, desktop computers or handheld mobile devices configured to access web pages. In yet another embodiment, the display device 340 may be a display of the server 105 or the application server 220.

The user account module 315 is configured to create a user profile. The user profile is created by a user who can be an individual and/or an organization. The user account module 315 is further configured to request the user to enter personal and professional information. The personal and professional information entered by the user may include, but is not restricted to, name, contact information, present employment details, previous employment details, education details, and so on. Upon creating the user profile, a unique identifier (ID) is created by the user account module 315, and the personal and professional information entered by the user is associated and stored in the memory 310 along with the created unique ID.

The expertise module 320 is configured to update the created user profile with a one or more first expertise, upon receiving a request from the user for updating the user profile with the one or more first expertise. First expertise as defined herein, includes, but is not limited to, domain expertise and/or functional expertise and/or client industry expertise of the user. Domain expertise is the expertise a user may possess in a particular area or topic, whereas functional expertise is the expertise that a user may possess based on having played a functional role in relation to the particular domain. The client industry expertise reflects the knowledge that the user possesses about customers and the industry in the domain in general, which knowledge is typically developed due to the user's prior experience from working with customer and industries in that particular domain. For example, a management consultant having an engineering background with customers in the telecom and automotive industries will have domain expertise in engineering, with functional expertise project consultancy, whereas his industry expertise will pertain to telecom and automobile industries.

In an embodiment of the present disclosure, the expertise module 320 is configured to present the user a pre-populated list of domains, functional roles and industry list, from where a user selects one or more domains and the corresponding function and industries in which her/she possesses expertise, which selection is then associated with the user profile of the user and stored in the memory 310. Furthermore, the expertise module 320 is configured to receive manual inputs from the user should a domain, function or industry not be made available in the pre-populated list.

In one embodiment of the present disclosure, upon updating the user profile with one or more first expertise, the rating module 330 invokes a self-rating stage. The self-rating stage is essentially a self-evaluation process which comprises the user being presented with a self-rating form having the one or more first expertise updated by the user. The user is requested to enter a rating against at least one rating in the form numerical values against each of the updated one or more first expertise. The numerical values may be further assigned legends, for instance, numerical value of 5 is assigned “excellent,” numerical value of 4 is assigned “good,” numerical value of 3 is assigned “average,” numerical value of 2 is assigned “below average,” and numerical value of 1 is assigned “cannot be assessed.” In this way, the user self-evaluates himself/herself and his/her level of expertise before inviting a reviewer for further evaluation. The user may however choose not to self-evaluate by entering a numerical value of 0 against one or all of the updated first expertise. The self-rating form is captured by the rating module 330 and stored in the memory 310 along with the unique ID of the user.

Further, upon updating the one or more first expertise to the user profile, the reviewer invite module 325 sends invites to a one or more reviewers, who may be selected by the user for evaluating and rating the user, upon receipt of an appropriate request from the user. The evaluation and rating are carried out with respect to the updated one or more expertise of the user, and additionally, a one or more second expertise. The one or more second expertise includes soft-skills expertise of the user, which are intrapersonal and interpersonal skills that determine a person's ability to excel or at least fit in a particular social structure, such as a project team, or a company. These skills include, but are not limited to, competencies in areas such as Emotional Intelligence, communication, leadership ability, etiquette, conflict resolution, decision making, self-motivation, self-discipline, persuasion, etc. Alternatively, the reviewer invite module 325 may also store information about the reviewers being invited in the memory 310 and set the status of review to pending.

Upon a reviewer accepting the invite from the user, the rating module 330 invokes an evaluation stage wherein the rating module directs the reviewer to the profile of the user and presents to the reviewer a review-rating form comprising the updated first expertise of the user and one or more second expertise.

In one embodiment, the reviewer rates the user by entering numerical values against each of the updated one or more first expertise and second expertise presented to the reviewer in the review-rating form. The numerical values may be further assigned legends, for instance, numerical value of 5 is assigned “excellent,” numerical value of 4 is assigned “good,” numerical value of 3 is assigned “average,” numerical value of 2 is assigned “below average,” and numerical value of 1 is assigned “cannot be assessed.” The rating module 330 captures the ratings entered by the reviewer in the review-rating form and stores it in the memory 310 along with the unique ID of the user.

In a further optional embodiment, the rating module is configured to retrieve and present to the reviewer a user's self-rating form during the evaluation stage, comprising the user's self-evaluation of his/her updated one or more first expertise, retrieved from the memory 310. This helps the reviewer understand the user's self-evaluation of his/her own first expertise.

In one embodiment, the user is evaluated for second expertise only. In another embodiment, the rating module 330 is further configured to receive comments in the form of text, from a reviewer, against each of the updated one or more first expertise and/or the one or more second expertise and/or the user in general. Further, rating module 330 is configured to allow reviewers to keep their comments anonymous or present the reviewer name against the comments posted.

Upon completing the review-rating form, the status of the review is set to complete by the reviewer invite module 325, and the computation module 335 is notified. The computation module 335 is configured to access ratings captured by the rating module 330 in the review-rating form, and compute a domain rating, a trust rating and trustworthiness score based on the ratings received from the reviewer in relation to user's first expertise and second expertise.

In one embodiment, the computation module 335 computes the domain rating and trust rating by aggregating ratings received by the user in relation to his/her updated one or more first expertise and second expertise, respectively. Further, the trustworthiness score is computed by aggregating the domain and trust ratings. In one embodiment, the computation module 335 accesses the review-rating forms of all reviewers in the memory 310 and computes an aggregate trustworthiness score, the domain rating and the trust rating for a user. The computed trustworthiness score, domain rating and trust rating are associated with the unique ID of the user and stored in the memory 310.

The computed domain rating, trust rating and trustworthiness score are then displayed on the user profile whenever the user profile is accessed either by the user or by any other users. In one embodiment, the computed domain rating, trust rating and trustworthiness score calculated based on the evaluations received from each and every reviewer are individually displayed on the user profile. In yet another embodiment, only aggregate scores and ratings are displayed on the user profile. In yet another embodiment, the domain rating, trust rating and trustworthiness score are displayed on the user profile only after reaching a certain threshold limit, for instance, trustworthiness score may be displayed on the user profile only upon three or more reviewers having evaluated the user for the first expertise and the second expertise. In one embodiment, the user profile is displayed on a display device at a user end. The computed domain rating, trust rating and trustworthiness score may be further displayed with the help of legends to provide comprehensive information about the user's domain expertise and trustworthiness.

In yet another embodiment, the computer system 300 described above is also used to evaluate trustworthiness of an entire organization wherein the user being an organization may be reviewed and evaluated for its expertise and trustworthiness by individuals or organizations who are in some way associated or have had business dealings with the organization. In one embodiment, the organization may be divided into several organizational units such as parent, subsidiary, service line, functional units, employee, and so on. Further, each of the organizational units may be evaluated by one or more reviewers and a trustworthiness score, domain rating and trust rating for each unit may be displayed on the user profile. In another embodiment, an aggregated or a unified domain rating, trust rating and/or trustworthiness score of the entire organization may be displayed by aggregating the ratings and scores received for each organizational unit. In another embodiment, the computation module 335 is configured to not use any or some of the ratings received for the sub-organization units in calculating the domain rating, trust rating and/or trustworthiness score depending on the reviewers being external or internal to the organization or sub-organization unit.

In yet another embodiment, the system 300 may be used by human resource units of an organization to evaluate users for appraisals and performance reviews, wherein the users comprise employees of the organization.

The computer system 300 described above may be used in a client-server scenario as shown in FIG. 1 and FIG. 2. The modules in the memory of the computer system 300 may reside either in a client computer or the server or both and comprise computer-readable instructions that may be executed by the processor 305.

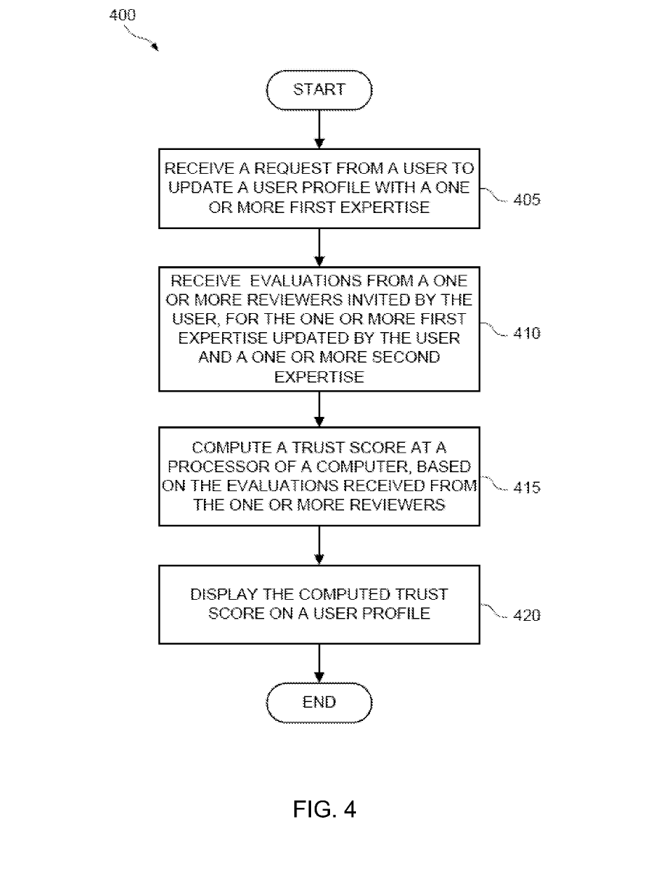

FIG. 4 illustrates a flowchart 400 of a method for evaluating trustworthiness of individuals and organizations in a social network, according to an embodiment of the present disclosure. At process block 405, a request is received from a user to update a user profile with a one or more first expertise. The user creates the user profile upon creating a user account. Upon creating the user account, a unique ID is created for the user. The user may include, but is not limited to, an individual and/or an organization or a sub-unit of an organization, e.g., a subsidiary or business unit. Further, the user may create the user profile by entering personal and professional information. The personal and professional information entered by the user includes, but is not restricted to, name, contact information, present employment details, previous employment details, education details, and so on. The personal and professional information entered by the user in the user profile is associated with the unique ID and stored in a database.

Receiving the request from the user for updating the one or more first expertise to the user profile includes the user selecting one or more domain expertise and the corresponding functional and industrial expertise from a pre-populated list and manually entering the above using the expertise module 320.

In another embodiment, receiving the request from the user for updating the user profile with one or more first expertise further includes receiving a self-rating upon self-evaluation of the updated one or more first expertise by the user. The self-rating includes presenting a self-rating form to the user, having the updated one or more first expertise of the user and receiving a numerical value from the user against each one or more updated first expertise in the self-rating form, and storing the self-rating form in a database. For instance, the numerical values entered are in numerical range (e.g., 1 to 5, where 1 is given less weight than 5, or vice versa). In an exemplary embodiment, legends are assigned to the numerical values. For instance, for the numerical range of 1 to 5, numerical value of 5 is considered as “excellent,” numerical value of 4 is considered as “good,” numerical value of 3 is considered as “average,” numerical value of 2 is considered as “below average,” and numerical value of 1 is considered as “cannot be assessed.”

At process block 410, evaluations/ratings are received from a one or more reviewers invited by the user, for the one or more first expertise updated by the user, and a one or more second expertise which includes soft-skill expertise of the user.

Receiving ratings from the one or more reviewers includes presenting a review-rating form having the one or more first expertise updated by the user along with one or more second expertise, and receiving numerical ratings from the reviewer against the one or more first expertise updated by the user, and the one or more second expertise. In one embodiment, the one or more reviewers evaluate and provide ratings for the second expertise only.

In an optional embodiment, receiving ratings further comprises presenting to the reviewer a user's self-rating having at least one rating received from the user in relation to one or more first expertise updated by the user. This is done to present to the reviewer the user's self-evaluation of his/her first expertise.

Upon completing the review-rating form, the review-rating form is assigned a review ID and saved in the database. The review ID of the review-rating form is then associated with the unique ID of the user profile and with the user ID of the reviewer.

In yet another embodiment, upon accepting the invites received from the user, the reviewer is requested to indicate its relationship with the user to be evaluated. For instance, the type of relationship may be working business relationship, such as an employer, client, colleague, or simply a friend/acquaintance.

In yet another embodiment, the invited one or more reviewers are contacts of the user within the social network, or contacts of the user outside the social network. Further, the contacts of the user within the social network include, but are not restricted to, contacts within a current organization, or previously worked organizations of the user. In case the one or more reviewers are contacts of the user outside the social network, then, such one or more reviewers are invited to review the one or more first expertise and one or more second expertise by sending the review-rating form to an external email address. Upon receiving the review-rating form, the one or more reviewers may evaluate the one or more first expertise and the one or more second expertise in the review-rating form as a guest user, or may send a request to the user to become a member of the social network and then evaluate the one or more first expertise and the one or more second expertise. In case the one or more reviewers evaluate the one or more first expertise and the one or more second expertise in the review-rating form as guest user, upon completing the review-rating form, a guest ID is created which is linked to the review ID.

In yet another embodiment, the computer-implemented method includes assigning different weights to ratings received from different reviewers based on the level and/or type of connection and/or relationship that is indicated by the reviewer. For instance, more weight may be assigned to the reviewer with whom the user has had a working business relationship, such as an employer or client, and less weight may be assigned to reviewers who are colleagues or friends with the user, to account for bias in computation of the final trustworthiness score.

At process block 415, a domain rating, a trust rating and a trustworthiness score are computed at a processor of a computer, based on the evaluations and the corresponding ratings received from one or more reviewers. In one embodiment, computing the trustworthiness score for a user includes computing domain rating for the one or more first expertise updated by the user, and trust rating for the one or more second expertise, respectively, and computing an aggregate of the domain rating and the trust rating to arrive at the trustworthiness score.

In yet another embodiment, the computed domain rating, trust rating and trustworthiness score are presented as numerical values. For instance, the computed domain rating, trust rating and trustworthiness score are presented in the numerical value range of 1 to 5. In yet another embodiment, legends may be assigned to the trust rating, domain ratings and trustworthiness score. For instance, the legends assigned for the trustworthiness score may be “master” for range of 4.5 to 5, “expert” for range of 4-4.5, and “not rated” for a range below 5. In one embodiment, the user chooses to compute the domain rating or the trust rating. Similarly, legends may also be assigned to the domain ratings.

At process block 420, the computed domain rating, trust rating and trustworthiness score are displayed on a user profile. The computed domain, trust rating and/or trustworthiness score are displayed on the user profile whenever a user tries to access the user profile. In one embodiment, the computed domain rating, trust rating and trustworthiness score based on the evaluations received from each and every reviewer are individually displayed on the user profile. In yet another embodiment, only aggregate ratings and scores are displayed on the user profile. In yet another embodiment, the domain rating, trust rating and trustworthiness score are displayed on the user profile only after reaching a certain threshold limit. For instance, the trustworthiness score may be displayed on the user profile only upon three or more reviewers having evaluated the user for the first expertise and the second expertise. In one embodiment, the user profile is displayed on a display device at a user end. The domain rating, trust rating and trustworthiness score may be further displayed with the help of legends to provide comprehensive information about the user's domain expertise and trustworthiness.

The computer-implemented method described above is also used to evaluate the trustworthiness of an entire organization wherein the organization may be reviewed and evaluated for its expertise and trust worthiness by individuals or organization who are in some way associated or have had business dealings with the organization. In one embodiment, the organization may be divided into several organizational units such as parent, subsidiary, service line, functional units, employee, and so on. Further, each of the organizational units may be evaluated by one or more reviewers, and a domain rating, trust rating and/or trustworthiness score for each unit may be displayed on the user profile. In another embodiment, an aggregated or a unified rating or score of the entire organization may be displayed by aggregating the trustworthiness scores received for each organizational unit. In another embodiment, the method involves not using any or some of the ratings and trustworthiness scores of the sub-organization units depending on the reviewers being external or internal to the organization or sub-organization unit.

In yet another embodiment, the system 300 may be used by human resource units of an organization to evaluate users for appraisals and performance reviews, wherein the users comprise employees of the organization.

In yet another embodiment, the computer-implemented method described above may be implemented in a client-server scenario as shown in FIG. 1 and FIG. 2. In the client-server scenario, a client computer such as client computer 115, and a server 105 such as application server 220, communicate through a network. In the client-server scenario the request is received from the user through a client application such as client application 205 on the client computer 115 of the user. Further, the information captured by the client application 205 is sent to the application server 220. Similarly, the evaluations received from the one or more reviewers are also sent to the application server 220. Additionally, the processor of the application server 220 computes a domain rating and a trust rating based on the received evaluations.

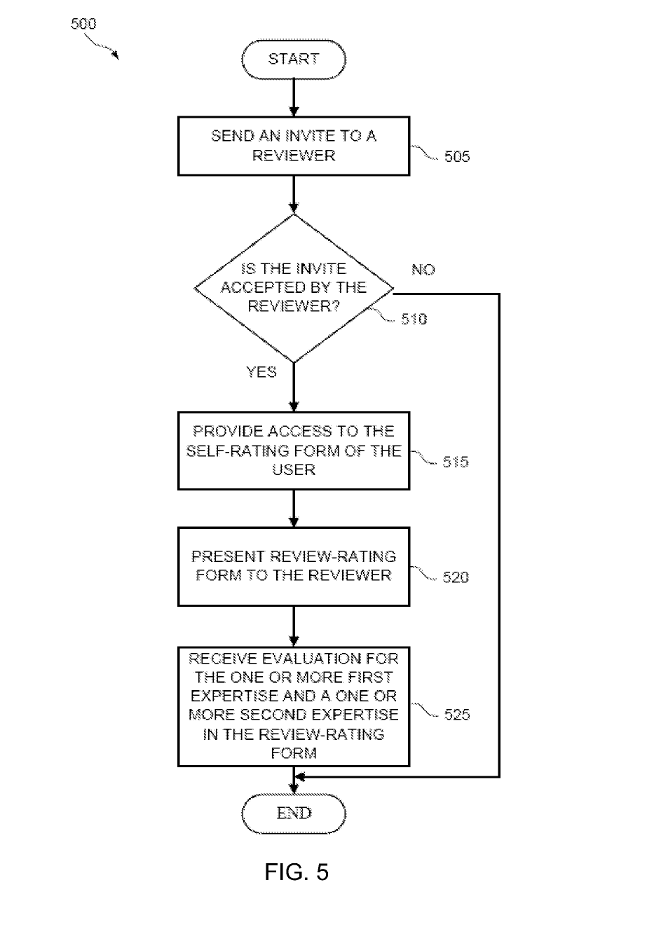

FIG. 5 illustrates a flowchart 500 for evaluating a one or more first expertise and a one or more second expertise by a reviewer, according to an embodiment of the present disclosure. At process block 505, an invite is sent to a reviewer. At decision block 510, it is checked if the reviewer accepts the invite. If yes, the process proceeds to process block 515. At process block 515, access is provided to a self-rating form of the user. Further, the self-rating form is retrieved from a database and presented to the reviewer. The process then proceeds to process block 520. At process block 520, a review-rating form is presented to the reviewer. The review-rating form includes the updated one or more first expertise and a one or more second expertise. At process block 525, review-ratings for the one or more first expertise and the one or more second expertise are received. Upon receiving the review-ratings, the review-rating form is saved along with a unique ID, and the process is ended,

At decision block 510, if the reviewer does not accept the invite, the process is ended.

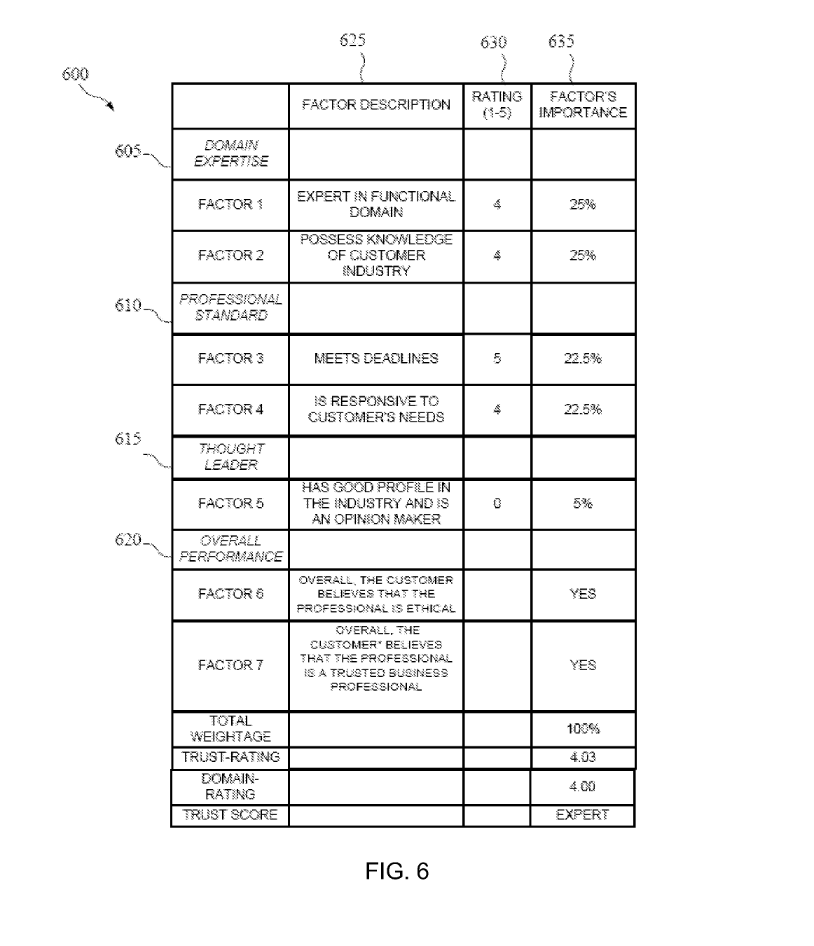

FIG. 6 illustrates an exemplary table 600 including computed trustworthiness score, domain rating and trust rating for an individual, according to an embodiment of the present disclosure. Table 600 includes ratings received by a user in relation to first expertise 605, comprising domain, expertise functional expertise and client industry as factor 1 and factor 2, and second expertise comprising soft-skill expertise, such as professional standard 610, thought leader 615 and overall performance 620. The factor description associated with the first expertise and second expertise are denoted by column 625. Furthermore, review-ratings entered by a reviewer are listed in column 630. A factor's importance or the weight assigned to of each factor is denoted in column 635. The weight may be specified or defined based on the type of relationship between the user and the reviewer indicated by the reviewer.

According to the example, factor 1 (referred as F1) and factor 2 (referred as F2) are factors pertaining to the first expertise, and factor 3, factor 4, factor 5, factor 6 and factor 7 (referred as F3, F4, F5, F6 and F7) are factors pertaining to the second expertise. The reviewer enters a review-rating upon viewing the factor description of the factors F1 and F2. The review-ratings entered by the reviewer for both F1 and F2 are 4. Further, the review-rating entered for second expertise F3, F4, F5 are 5, 4 and 0, respectively. Factors F6 and F7 are made mandatory to be answered “yes” or “no” for the rating to be computed. If either F6 or F7 are answered as “no”, then the trust-rating is shown as “Not Rated.”

A domain rating is computed by calculating an average of review-ratings received for F1 and F2, i.e., (R1+R2)/2, which results in 4. In another embodiment of the present disclosure, the domain rating may also be computed based on a weighted average.

A trust rating is computed based on F1 to F5 factors by calculating sum product of weights and ratings, i.e., (W1×R1+W2×R2+W3×R3+W4×R4+W5×R5), which results in 4.03.

A trustworthiness score is calculated based upon the aggregate computation of the domain rating and trust rating. In this example, the trustworthiness score is calculated and a legend “Expert” is assigned. For example, trustworthiness scores between 4.5 and 5 are assigned “Master,” trustworthiness scores between 4 and 4.49 are assigned “Expert,” and trustworthiness scores below 4 are assigned “Professional” and “Not Rated.”

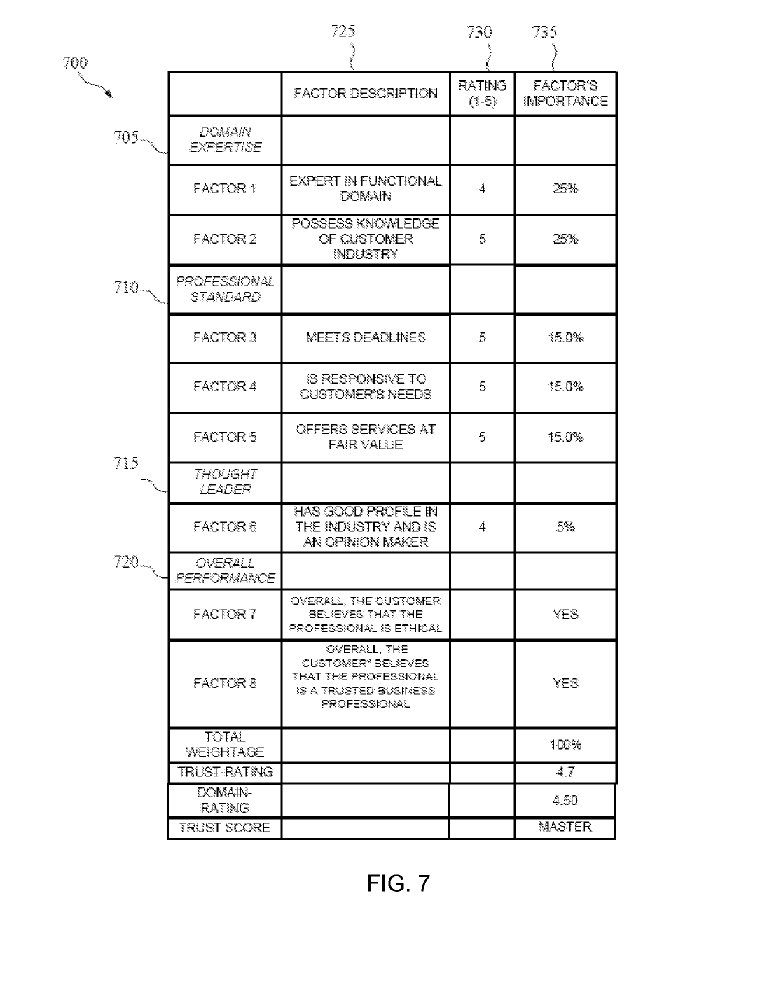

FIG. 7 illustrates an exemplary table including computed trustworthiness score, domain rating and trust rating for an organization, according to an embodiment of the invention. Table 700 includes ratings received by a user in relation to first expertise 705 comprising domain expertise, functional expertise and client industry, as factor 1 and factor 2, and second expertise comprising soft-skill expertise, such as professional standard 710, thought leader 715 and overall performance 720. The factor description associated with the first expertise and the second expertise are denoted by column 725. Furthermore, review-ratings entered by a reviewer against each factor are listed in column 730. A factor's importance is denoted in column 735.

According to the example, factor 1 (referred as F1) and factor 2 (referred as F2) are factors pertaining to the first expertise, and factor 3, factor 4, factor 5, factor 6 and factor 7 (referred as F3, F4, F5, F6, F7 and F8) are factors pertaining to the second expertise. The reviewer enters a review-rating upon viewing the factor description of the factors F1 and F2. The review-rating entered by the reviewer for F1 and F2 are 4 and 5, respectively. Further, the review-ratings entered for the second expertise F3, F4, F5 and F6 are 5. Furthermore, trust related factors F7 and F8 are made mandatory to be answered “yes” or “no” for the rating to be computed. If either F7 or F8 are answered as “no”, then the trust-rating is “Not Rated.”

A domain rating is computed by calculating an average of review-ratings received for F1 and F2, i.e., (R1+R2)/2, which results in 4.5. In another embodiment of the present disclosure, the domain rating may also be computed based on a weighted average.

A trust rating is computed based on F1 to F6 factors by calculating a sum product of weights and ratings, i.e., (W1×R1+W2×R2+W3×R3+W4×R4+W5×R5+W6×R6), which results in 4.7.

A trustworthiness score is calculated based upon the aggregate computation of the domain rating and trust rating. In this example, the trustworthiness score is calculated and a legend “Master” is assigned. For example, trustworthiness scores between 4.5 and 5 are assigned “Master,” trustworthiness scores between 4 and 4.49 are assigned “Expert,” and trustworthiness scores below 4 are assigned “Professional” and “Not Rated.”

The computer-implemented method and the computer system described above are used for evaluating trustworthiness of individuals and organizations in social network platforms such as personal social network platforms, professional social network platforms and business social network platforms. The described computer-implemented method and computer system may also be extended to standalone applications.

Exemplary aspects, features, and components of the system are described above. However, the system may be implemented in many different ways. For example, although some features are shown stored in computer-readable memories (e.g., as logic implemented as computer-executable instructions or as data structures in memory), all or part of the system and its logic and data structures may be stored on, distributed across, or read from other machine-readable media. The media may include hard disks, floppy disks, CD-ROMs, a signal, such as a signal received from a network or received over multiple packets communicated across the network.

The system may be implemented with additional, different, or fewer components. As one example, a processor may be implemented as a microprocessor, a microcontroller, a DSP, an application specific integrated circuit (ASIC), discrete logic, or a combination of other types of circuits or logic. As another example, memories may be DRAM, SRAM, Flash or any other type of memory. The processing capability of the system may be distributed among multiple components, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (e.g., a dynamic link library (DLL)). The DLL, for example, may store code that prepares intermediate mappings or implements a search on the mappings. As another example, the DLL may itself provide all or some of the functionality of the system, tool, or both.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

1. A system to evaluate trustworthiness of a user in a social network, the system comprising:
a memory in communication with a processor for storing;
a user account module to create a user profile;
an expertise module to update the user profile with a one or more first expertise;
a reviewer invite module to invite reviewers to evaluate and rate the user;
a rating module configured to capture ratings received from the one or more reviewers; and
a computation module configured to compute a trustworthiness score;
wherein the user invites one or more reviewers to rate the user in relation to the updated one or more first expertise, the rating module captures the ratings received from the one or more reviewers in relation to the updated one or more first expertise and additionally a one or more second expertise of the user, and the computation module calculates a trustworthiness score from the ratings captured by the rating module.

2. The system of claim 1, wherein the expertise module receives at least one request to update user profile of the user with one or more first expertise.

3. The system of claim 2, wherein the one or more first expertise comprises a domain expertise, a functional expertise or a client industry expertise.

4. The system of claim 1, wherein the rating module invokes a self-rating stage upon the user updating the user profile with the one or more first expertise, and wherein the rating module presents to the user a self-rating form comprising the one or more first expertise updated by the user.

5. The system of claim 4, wherein the rating module receives at least one rating from the user in the self-rating form.

6. The system of claim 1, wherein the rating module invokes an evaluation stage upon a reviewer accepting a user invite, wherein the rating module presents a review rating-form comprising the user's updated first expertise and the one or more second expertise to the reviewer.

7. The system of claim 6, wherein the one or more second expertise of the user comprises a soft-skill expertise such as but not limited to interpersonal and intrapersonal skills.

8. The system of claim 6, wherein the rating module receives at least one rating in relation to the first expertise and the one or more second expertise of the user in the review-rating form.

9. The system of claim 6, wherein the rating module is further configured to retrieve and present to the reviewer the user's self-rating from the memory during the evaluation stage.

10. The system of claim 6, wherein the rating module is further configured to receive comments from the reviewer in relation to one or more ratings received by the rating module.

11. The system of claim 1 wherein the reviewer invite module sets status to review pending upon the user inviting reviewers.

12. The system of claim 1, wherein the computation module computes a domain rating upon the rating module receiving at least one rating in relation to the one or more first expertise.

13. The system of claim 12, wherein the computation module computes a trust rating based upon the rating module receiving at least one rating in relation to the one or more second expertise.

14. The system of claim 13, wherein the computation module computes a trustworthiness score by aggregating the domain rating and the trust rating.

15. The system of claim 1, wherein the system is a network-enabled system accessed using a desktop computer or a handheld mobile device connected to the network.

16. The system of claim 1, wherein the trustworthiness score of a user is displayed upon any user accessing the user's user profile on the network.

17. The system of claim 16, wherein the trustworthiness score is displayed only upon reaching a minimum threshold.

18. The system of claim 16, further comprising displaying reviewer comments with the computed trustworthiness score.

19. The system of claim 16, wherein the comments are displayed in an anonymous fashion.

20. A method for evaluating trustworthiness of a user in a social network, the method comprising the steps of:
receiving a request from the user for updating a user profile with a one or more first expertise;
receiving ratings from a one or more reviewers in relation to the updated one or more first expertise and additionally a one or more second expertise of the user;
computing a trustworthiness score at a processor of a computer, based on the ratings received from the one or more reviewers; and
displaying the computed trustworthiness score on the user profile.

21. The method of claim 20, wherein updating the user profile with the one or more first expertise comprises updating the user profile with one or more domain expertise, functional expertise or client industry expertise.

22. The method of claim 20, wherein updating the user profile with the one or more first expertise further comprises receiving a self-rating from the user in relation to the one or more first expertise updated by the user.

23. The method of claim 20, wherein receiving ratings from the reviewer comprises:
presenting a review-rating form having the one or more first expertise updated by the user along with one or more second expertise; and
receiving at least one rating from the reviewer in the review-rating form in relation to the one or more first expertise and the one or more second expertise of the user.

24. The method of claim 23, wherein the one or more second expertise of the user comprises a soft-skill expertise such as but not limited to interpersonal and intrapersonal skills.

25. The method of claim 23, wherein receiving ratings from the user comprises presenting the reviewer with a self-rating form of the user having at least one rating received from the user in relation to one or more first expertise updated by the user.

26. The method of claim 20, wherein computing the trustworthiness score comprises computing a domain rating and a trust rating from the ratings received in the review rating-form.

27. The method of claim 26, wherein the domain rating is computed from the ratings received in relation to the first expertise.

28. The method of claim 26 wherein the trust rating is computed from the ratings received in relation to the second expertise.

29. The method of claim 26, wherein computing the trustworthiness score comprises assigning different weights to the one or more first expertise and the one or more second expertise.

30. The method of claim 26, wherein computing the trustworthiness score comprises assigning different weights to ratings received from one or more reviewers.

31. The method of claim 20, wherein the trustworthiness score is displayed on the user profile only upon reaching a minimum threshold.

32. The method of claim 20, wherein trustworthiness score is displayed on the user profile using legends.
